(19) United States
(12) Patent Application Publication
(10) Pub. No.: US 2009/0249854 A1
(43) Pub. Date: Oct. 8, 2009

(54) Apparatus for rotationally locking a roller-mill roll in t

(76) Inventor: Wolfgang Denker, Freudenberg (DE)

Correspondence Address: K.F. ROSS P.C., 5683 RIVERDALE AVENUE, SUITE 203 BOX 900, BRONX, NY, 10471-0900, US

(21) Appl. No.: 11/578,736

(22) PCT Filed: May 12, 2006
(86) PCT No.: PCT/EP2006/004463

§ 371 Date: Oct. 17, 2006

(30) Foreign Application Priority Data
May 14, 2005 (DE) 102005022440.7

(51) Int. Cl. B21B 31/08; F16C 35/02; B21B 31/02

(52) U.S. Cl. 72/239; 384/435; 72/238

(57) ABSTRACT

An apparatus for rotationally locking a rolling-mill roll in the bearing mount LS in a rolling-mill frame has an axially shiftable housing fitted to the stub (WZ) of the roll, having a planar flange (FA) that in one position of the housing bears on an abutment face of an abutment element fixed in the bearing mount (LS).

The invention relates to an apparatus for rotationally locking a rolling-mill roll in a bearing mount in a mount window of a rolling-mill frame. When changing such rolls one normally uses rail systems with whose help the rolls are shifted with their bearing mounts through the mount windows of the rolling-mill frame. These rails and the equipment used for such an operation take a great deal of space up at the roll frame and make it difficult to mount or move other equipment needed for rolling.

It has therefore been suggested to change rolls by means of a support beam, a so-called porter bar. To this end the stub of the roll is connected to a porter bar suspended from a crane, and the roll is lifted in this position out of the frame. With this method there is the problem that the bearing mount rotates on the roll as it is being moved. The object of the invention is to provide an apparatus that rotationally locks the bearing mount to the roll during removal, transport, and reinstallation in the roll frame and until it is reconnected to the drive element. This object is achieved by an axially shiftable cylindrical housing fitted to the stub of the roll, having a planar flange that in one position of the housing bears on an abutment face of an abutment element fixed in the bearing mount so that the cylindrical housing is rotationally locked in the bearing mount. Further according to the invention the housing is a cylindrical flange ring having the flange with a planar face. Further features of the invention are described in the dependent claims.

The invention will be more closely described with reference to the embodiment of the apparatus shown in the drawing. In the drawing in a schematic illustration:

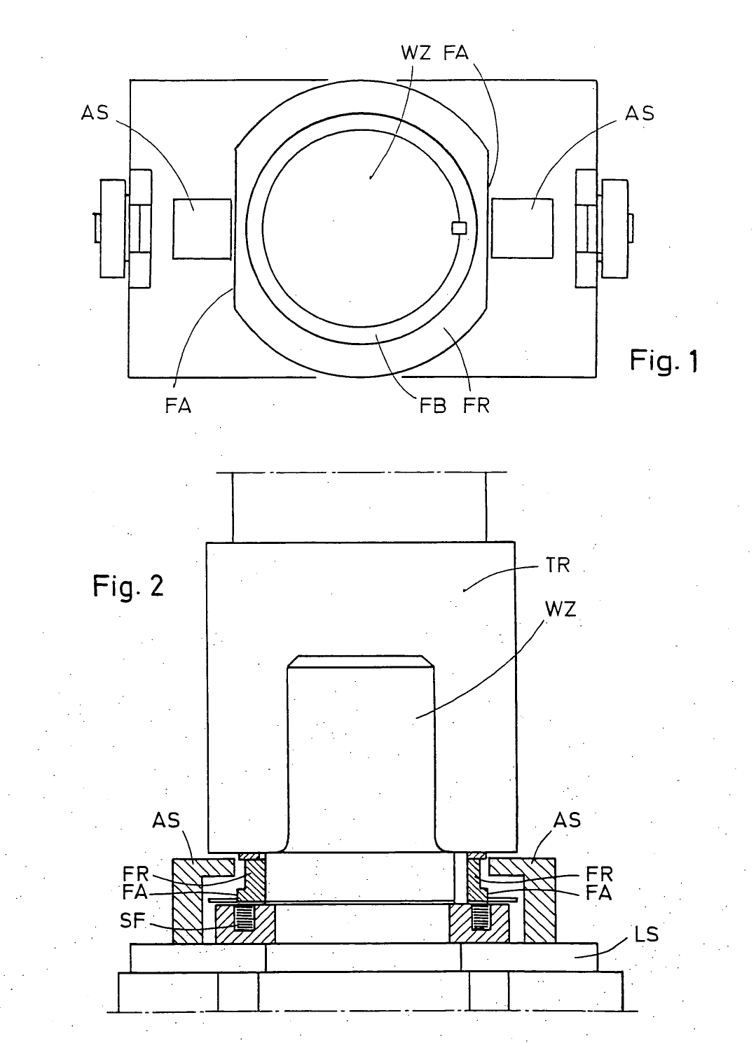

FIG. 1 is a radial section through a roll stub and slide housing in the direction of the bearing mount;

FIG. 2 is a side view of the section of FIG. 1;

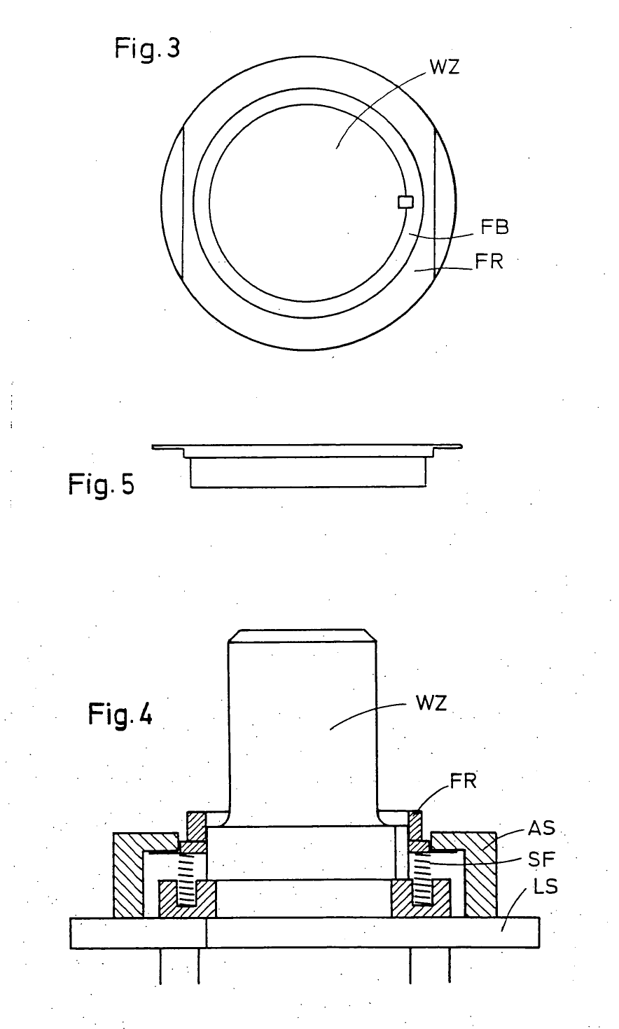

FIG. 3 is a view of another radial section like FIG. 1;

FIG. 4 is a side view of FIG. 3; and

FIG. 5 is a detail of the view of FIG. 3.

As shown in FIGS. 1 and 2 a roll stub WZ carries an axially shiftable flange sleeve FB having a flange ring FR and a planar outer flange FA. A bearing mount LS has abutments AS with abutment faces for the planar flange FA of the flange ring FR. As shown in FIG. 2 the roll stub WZ is fitted to the drive element TR of the roll drive, and the lower face of the flange ring FR is supported in the bearing mount LS on springs SF that push the flange ring FR against an end face of the drive element TR. In this position the planar flange FA of the flange ring FR is offset from the abutments AS so that the roll stub WZ with the flange ring FR can rotate freely in the bearing mount LS. If the roll stub is separated from the drive element TR as shown in FIG. 4 to carry off the roll, the springs SF push the flange ring in the bearing mount LS into a position in which its abutment face AF bears on the abutments AS and the flange ring is blocked against rotation on the roll stub WZ. This blocking is effective until the roll with the bearing mount LS is fitted to the roll frame and the roll stub WZ is fitted to the drive element TR to shift the flange ring FR back into the FIG. 2 position.

Reference List

| | |
|---|---|
| WZ | Roll stub |
| FR | Flange ring |
| FA | Flange |
| LS | Bearing mount |
| AS | Abutments |
| TR | Drive element |
| SF | Support springs |

1. An apparatus for rotationally locking a rolling-mill roll in the bearing mount LS in a rolling-mill frame, characterized by
an axially shiftable housing fitted to the stub (WZ) of the roll, having a planar flange (FA) that in one position of the housing bears on an abutment face of an abutment element fixed in the bearing mount (LS).

2. The apparatus according to claim 1, characterized in that
the housing is a flange ring (FR) having the flange (FA) with a planar face.

3. The apparatus according to claim 1, characterized in that
the flange ring (F) is supported in the bearing mount (LS) on springs (SF).

4. The apparatus according to claim 1, characterized in that
the flange ring (F) is supported in the bearing mount (LS) on springs (SF).

5. In a rolling-mill roll having a roll stub rotatable about an axis in a stationary bearing mount and fittable axially with a rotatable drive element, an apparatus comprising:
an annular housing rotationally fixed and axially shiftable on the roll stub and axially engageable with the drive element and with a stationary abutment face of the bearing mount, whereby engagement of the housing with the abutment face rotationally arrests the roll stub in the bearing mount; and
springs axially braced against the housing and urging the housing axially toward the drive element and toward the stationary abutment face, whereby engagement of the drive element with the housing pushes the housing out of engagement with the abutment face.

6. The apparatus defined in claim 5 wherein the housing has a planar flange engageable with the abutment face.

7. The apparatus defined in claim 5 wherein the springs are axially extending compression springs.
